(19) United States
(12) Patent Application Publication
(10) Pub. No.: US 2019/0338586 A1
(43) Pub. Date: Nov. 7, 2019

(54) Architectural Covering With Light Transmitting Material

(71) Applicant: Hunter Douglas Inc., Pearl River, NY (US)

(72) Inventor: Paul G. Swiszcz, Niwot, CO (US)

(21) Appl. No.: 16/398,829

(22) Filed: Apr. 30, 2019

Related U.S. Application Data
(60) Provisional application No. 62/665,878, filed on May 2, 2018.
(60) Provisional application No. 62/666,181, filed on May 3, 2018.

(51) Int. Cl. E06B 9/52; E06B 9/34; E06B 9/262; B29C 65/00

(52) U.S. Cl. CPC E06B 9/52; E06B 9/34; E06B 2009/524; B29C 66/83431; E06B 9/262

(57) ABSTRACT

A covering for an architectural feature includes a light transmitting or sheer material that has an openness factor of about 60% or greater. The light transmitting material can include a pattern of geometric shapes, such as polygons. In one embodiment, the geometric shapes are hexagons that extend in alternating columns along the length of the light transmitting material. The hexagons can be formed in a knitted fabric, such as a warp knitted fabric. The fabric can be formed from monofilament yarns.

### RELATED APPLICATIONS

The present application claims priority to U.S. Provisional Application Ser. No. 62/665,878, filed May 2, 2018, and U.S. Provisional Application Ser. No. 62/666,181, filed May 3, 2018, which are incorporated herein in their entirety by reference hereto.

### FIELD OF THE INVENTION

The present disclosure relates to sheer fabrics and to coverings for architectural features that include sheer fabrics.

### BACKGROUND

Various different coverings exist for architectural features or openings, which may include windows, doorways, archways, and the like. The coverings, for instance, can provide privacy, can block views from the outside, can provide thermal insulation, and/or can be aesthetically pleasing. Coverings for architectural features can take many forms and can include a fabric or other material that is designed to be suspended adjacent to an architectural feature by operating mechanisms that may be capable of extending and retracting the fabric or material.

Coverings for architectural features, for instance, can be configured to be extended and retracted in numerous ways. In one embodiment, for instance, the covering can include a rotatable roller that winds and unwinds material for retracting and extending the covering (e.g., about or from the roller, respectively). Other coverings include stacking type coverings in which the bottom of the covering is brought closer to the top of the covering to retract or open the covering from an extended or closed position or configuration. For instance, Roman shades hang substantially flat when lowered and include battens or other stiffening elements which cause the covering fabric to gather in generally uniform folds when the covering is retracted. Still another type of covering is referred to as a cellular shade. Cellular shades are made from a series of cells which generally collapse or fold into stacks when the covering is retracted.

One type of distinctive covering for architectural features is sold under the brand name Silhouette® by Hunter Douglas, which is described in U.S. Pat. No. 5,313,999, and which is incorporated herein by reference in its entirety. Such coverings, for instance, can include generally vertical front and back sheets that support generally horizontal vane elements. The vertical sheets (often referenced herein as support sheets) are typically made from materials that allow a substantial amount of light to pass through the covering. Such materials are typically referred to as “sheer” materials which can be made with a relatively open weave. The vertical support sheets together with the substantially horizontal vanes form a flexible or soft-light controlling window covering or panel. The materials used to form the covering can be flexible in nature, allowing for the covering to be operated by rolling and unrolling the shade about a roller. Various other shades are known which also include sheer materials designed to allow a substantial amount of light to pass through the material for providing a visual appeal.

Although various sheer materials have been used in the past to produce coverings for architectural features, such materials can have a tendency to be dimensionally unstable, especially under load. Furthermore, increasing the openness of past materials generally reduces the dimensional stability. Thus, a need currently exists for a light diffusing covering for an architectural feature that not only allows a significant amount of light transmission but also has dimensional stability, especially when being retracted and extended within an architectural feature.

### SUMMARY

The present disclosure is directed to a person of ordinary skill in the art. The purpose and advantages of the architectural panel and covering will be set forth in, and be apparent from, the drawings, the description and claims that follow. The summary of the disclosure is given to aid an understanding of the panel and covering, and not with an intent to limit the disclosure or the invention. It should be understood that each of the various aspects and features of the disclosure may be advantageously used separately in some instances, or in combination with other aspects and features of the disclosure and other instances. Accordingly, while the disclosure is presented in terms of embodiments, it should be appreciated that individual aspects of any embodiment can be utilized separately, or in combination with aspects and features of that embodiment or any other embodiment. In accordance with the present disclosure, variations and modifications may be made to the architectural panel or covering to achieve different effects.

The present disclosure is generally directed to a covering for architectural features, which may include windows, doorways, archways, and the like, where the covering includes a panel made from a light transmitting material. The light transmitting material is designed and engineered to allow a significant amount of light to pass through the material for providing a desired visual effect while having improved dimensional stability. Improved dimensional stability indicates that the fabric is capable of withstanding forces exerted on the material in either the vertical direction or the horizontal direction. For instance, materials made in accordance with the present disclosure resist elongation when pulled in either the vertical direction or the horizontal direction. In this manner, the material doesn't distort during normal use, especially when extended or retracted.

In one embodiment, the covering for an architectural feature includes a light transmitting material that extends vertically. For example, the light-transmitting material may extend vertically from a head rail and may extend from a top of the covering to a bottom of the covering. As described above, the light-transmitting material is designed to have a significant amount of openness to allow light to pass through the material. The light transmitting material may include a pattern of geometric shapes. The geometric shapes can have five or more sides.

In one embodiment, the light transmitting material may be formed from a knitted fabric. The geometric shapes can extend in alternating columns along the length of the fabric. The knitted fabric can be made from various different types of yarns. The type of yarn, the size of the yarn, and the color of the yarn can be selected depending upon various factors. For instance, the type and size of yarn can be selected in order for the material to have a desired openness factor while also having sufficient strength properties. In addition, the type and size of the yarns can be selected so that the fabric will extend and retract such as on a roller or other mechanical device.

Various different types of coverings can incorporate the light transmitting material as described above. In one embodiment, for instance, the covering can include a roller that is engaged with the light transmitting material. The roller can be configured to rotate for winding and unwinding a light transmitting material thereby causing the material to retract and extend.

In an alternative embodiment, the covering includes a front vertical support member having a height and a width and a rear vertical support member having a height and a width. A plurality of generally horizontal vanes can extend between the front and rear vertical support members and can be configured for angular orientation. In accordance with the present disclosure, the front vertical support member, the rear vertical support member, or both the front vertical support member and the rear vertical support member can be made from a light transmitting material of the present disclosure as described above.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of one example of an embodiment of a light transmitting material made in accordance with the present disclosure;

FIG. 2 is a perspective view of one example of an embodiment of a covering for an architectural feature or opening that may incorporate light transmitting material of the present disclosure;

FIG. 3 is a perspective view of the covering illustrated in FIG. 2 shown with the horizontal vanes in the closed position;

FIG. 4 is a rear plan view of another example of an embodiment of a covering for an architectural feature that may incorporate light transmitting material of the present disclosure;

FIG. 5 is a perspective view of another example of an embodiment of a covering for an architectural feature or opening that may incorporate light transmitting material of the present disclosure;

FIG. 6 is a perspective view of the covering illustrated in FIG. 5 shown with the horizontal vanes in the closed position.

Repeat use of reference characters in the present specification and drawings is intended to represent the same or analogous features or elements of the present invention.

### DETAILED DESCRIPTION

It is to be understood by one of ordinary skill in the art that the present discussion is a description of examples of embodiments only, and is not intended as limiting the broader aspects of the present disclosure.

The present disclosure generally relates to coverings for architectural features which include, for example, windows, doorframes, archways, and the like. The coverings are particularly useful for windows to provide an aesthetic look and desirable shading and privacy. In accordance with the present disclosure, the coverings generally include a light transmitting material. The light transmitting material is constructed so as to have improved dimensional stability. For instance, the material is well suited for absorbing outside forces, such as stress, during use. Coverings for architectural features, for example, are typically exposed to forces in the vertical direction when extended or retracted, when pulled upon by a user, or when subjected to the force of gravity. Coverings are also subjected to forces in the horizontal direction when extended or retracted or when being moved or shifted by a user. The improved dimensional stability of the material of the present disclosure means that the material is resistant to elongation when pulled in either the vertical direction or the horizontal direction. For instance, the material is well suited for maintaining its shape under loads, such as dynamic loads (e.g., from a user operating the covering) and static loads (e.g., from the weight of the covering). Due to the improved dimensional stability, the material has excellent drape characteristics, such that a geometric pattern of the knit or weave of the material retains its shape while extended over an architectural feature.

In addition to excellent dimensional stability characteristics, in one embodiment, the light transmitting material is constructed to allow a significant amount of light to pass through the material while still providing a distinctive, unique, and/or appealing effect. As will be explained in greater detail below, the light transmitting material can be used in all different types of coverings architectural features.

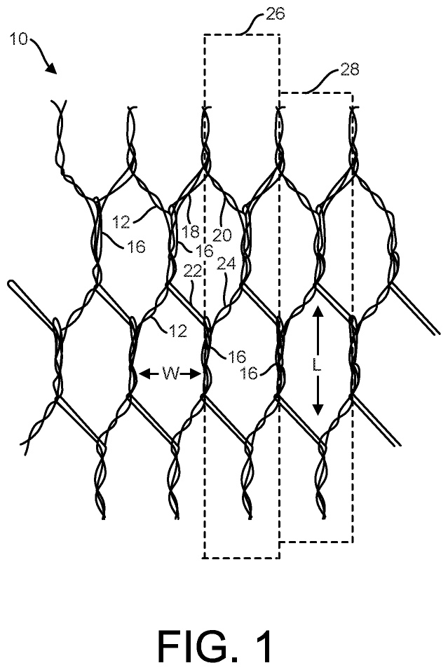

Referring to FIG. 1, one embodiment of a light transmitting material 10 made in accordance with the present disclosure is shown. As illustrated in FIG. 1, the light transmitting material 10 forms a sheer material that includes a pattern of geometric shapes. The geometric shapes may be polygons. The polygons, for instance, can have five sides or more, such as from about five sides to about ten sides. In one embodiment, the geometric shapes may have an even number of sides which may allow for increased dimensional stability. The geometric shapes, in one embodiment, can be regular polygons. As used herein, a regular polygon refers to a polygon in which each internal angle and/or the length of each side varies by no more than about 10%, such as by no more than about 5%, such as by no more than about 2%. In the embodiment illustrated in FIG. 1, the geometric shapes include hexagons 12 having six different sides. In an alternative embodiment, the geometric shapes may be octagons having eight different sides.

In the embodiment illustrated in FIG. 1, the geometric shapes or hexagons 12 extend in a lengthwise or first direction 14 of the light transmitting material 10. The hexagons 12, for instance, form columns 26 and 28 along the length direction 14. As shown in FIG. 1, the hexagons 12 form alternating columns 26 and 28 such that hexagons 12 in one column 26 are offset with respect to hexagons 12 in an adjacent column 28.

The dimensions of each hexagon 12 within the light transmitting material 10 can depend upon various factors and the desired properties. For instance, the dimensions of each hexagon 12 can depend upon the amount of openness desired for the particular application. In general, each hexagon 12 can have a length L of about 5 mm or greater, and about 20 mm or less, including all increments of about 1 mm therebetween. The width W of each hexagon 12 can generally be about 3 mm or greater, and about 15 mm or less, including all increments of about 1 mm therebetween.

The light transmitting material 10 of the present disclosure is designed to allow significant amounts of light to pass through the material while still having excellent dimensional stability characteristics. In this regard, the geometric shapes that form the light transmitting material 10 define openings within the material that allow significant amounts of light to transmit through the material. The amount of light that passes through the material can be measured by the amount of openness of the material. The openness of a material may be measured by its openness factor which measures the percent of open space in, for instance, a material, where a 60% openness factor has 40% material and 60% holes or open spaces. The higher the openness factor, the more sheer and greater transparency is provided by the material. One manner of measuring the openness factor is to measure the area of the yarns and/or open areas and calculate the percentage of area that has no material. In one example, a digital microscope or high resolution camera may be used to capture an image of the material and the image used to calculate the percentage that does not have fabric, yarns, or material. A Motic digital microscope and Motic Image Plus 2.0 Software may be used to measure the openness factor of various materials. In accordance with the present disclosure, the geometric shapes as shown in FIG. 1 can be designed to provide the appropriate openness factor for the light transmitting material for providing aesthetic appeal while also providing dimensional stability. In general, the light transmitting material 10 as shown in FIG. 1 has an openness factor of about 60% or greater, and about 95% or less, including all increments of about 1% therebetween, in order to provide the desired amount of light transmitting or pass through properties.

The light transmitting material 10 as shown in FIG. 1 can be made using various methods and techniques. In one embodiment, for instance, the light transmitting material 10 is a fabric, such as a woven or knitted fabric.

As described above, the light transmitting material 10 is made from a pattern of geometric shapes. The geometric shapes can have five or more sides. For example, the geometric shapes may be polygons, such as regular polygons, hexagons, such as regular hexagons, octagons, such as regular octagons, or other polygonal shapes. In one example in accordance with the present disclosure, the geometric shapes are hexagons 12. The pattern of hexagons 12 provides the material with a significant amount of openness while still having excellent dimensional stability properties. As shown in FIG. 1, each hexagon 12 has six sides. Two sides 16 of each hexagon 12 are positioned generally parallel to the lengthwise or first direction 14 of the material 12, which can also be a vertical direction as shown in FIG. 1. The two sides 16 of each hexagon 12 extend along the lengthwise or vertical direction 14 and provide the material with dimensional stability not only in the first direction 14 but also in the perpendicular direction or cross direction. Each side 16 of the hexagon 12 can be reinforced with stitches for further improving the integrity of the fabric. As illustrated in FIG. 1, each side 16 of each hexagon 12 extending in the first direction 14 contains at least one stitch where interlocking knitted loops are located. Each side 16 can contain at least one stitch, and less than six stitches, including all integer increments therebetween. In general, each side 16 may contain about one stitch, about two stitches, or about three stitches. The stitches can be formed from interlocking loops of the same warp yarn or from interlocking loops of different warp yarns.

In addition to the sides 16, each hexagon 12 includes sides 18, 20, 22 and 24. As shown in FIG. 1, in one embodiment, each side of the hexagon 16, 18, 20, 22 and 24 may be formed from at least two yarns, such as at least two monofilament yarns. Each of the sides, 18, 20, 22 and 24 can be formed from at least two yarns in order to further strengthen the hexagon structure and improve the dimensional stability of the overall fabric. The sides 18, 20, 22 and 24 may extend in a slanted or angled direction with respect to the lengthwise or first direction 14.

In one embodiment, the light transmitting material 10 is a knitted fabric formed from a parallel series of warp yarns. The warp yarns extend in the warp direction which in FIG. 1 is also the first direction 14. Each of the warp yarns can form a series of knitted loops extending in the first direction 14. Multiple yarns may be used so that a parallel series of knitted loops are formed. Each series of knitted loops alternately interlocks with adjacent series of knitted loops to form the sides 16 of the hexagon 12 as shown in FIG. 1. For example, after the fabric is formed, each of the warp knitted yarns form an alternating or a zigzag pattern within the fabric. In this manner, each warp knitted yarn extends along the first direction 14, forms one half of one of the hexagons 12 in one column 26 and then as the yarn extends further along the first direction 14 forms one half of a hexagon 12 in an adjacent column 28. In this manner, the warp knitted yarns form one half of the hexagons 12 that extend in the first direction 14 along offset columns 26 and 28. The warp knitted yarns interlock with adjacent warp knitted yarns along the sides 16 of the hexagons 12 to provide an integrated sheer fabric.

In one embodiment, if desired, unknitted warp yarns can also extend along the first direction 14 with the knitted warp yarns which are formed into a series of knitted loops. The unknitted yarns, for instance, can be carried through the loops and interlock with the loops as the loops are successively formed in series. The unknitted yarns, for instance, can further reinforce the fabric and the pattern of hexagons 12. Through this process, a dimensionally stable fabric is produced that is well suited to absorbing stress, such as the forces to which coverings are normally exposed when hanging over an architectural feature.

It should be understood, however, that the above knitted fabric represents only one embodiment of a fabric made in accordance with the present disclosure as shown in FIG. 1. Various other knit structures may be used to produce the geometric shapes with the desired amount of openness and dimensional stability.

As described above, the light transmitting material 10 can be constructed using various different weaving and knitting techniques. In one embodiment, the light transmitting material 10 is a knitted fabric, such as a warp knitted fabric. For example, the light transmitting material can be warp knitted using a Tricot warp knitting machine or a Raschel warp knitting machine. The warp knitting machine used may be a 16 gauge, 20 gauge, 24 gauge, 28 gauge, or 32 gauge machine depending upon the size of the yarns being used and the desired openness factor. In one embodiment, a warp knitted hexagon Tulle knit fabric is constructed. In one embodiment, the warp knitted fabric includes about 20 yarns per inch or greater in the warp direction, and about 50 yarns per inch or less in the warp direction, including all increments therebetween of 1 yarn per inch.

The size and type of yarns used to construct the light transmitting material 10 can depend upon various factors. For example, the size and type of yarns are selected so that the fabric can be made with a desired amount of openness. The size and type of yarns are also selected so that the resulting fabric has sufficient strength. The size and type of yarns, however, are also selected so that the light transmitting material 10 will have sufficient flexibility and have a thickness that allows the material to extend and retract. The size and type of yarns are also selected so that the material does not add an undesirable amount of weight to the covering. The yarns, for instance, comprise spun yarns, multifilament yarns, stretch broken yarns, monofilament yarns, or mixtures thereof. In some embodiments, the yarns are made from polymers. Polymers that may be used to form the yarns include, for instance, polyester, nylon polyamide, polyolefins such as polypropylene or polyethylene, polyoxymethylene, and the like.

In one embodiment, monofilament yarns are selected for constructing the light transmitting material. The monofilament yarns, for instance, can have a diameter of greater than about 25 microns, and less than about 1000 microns, including all increments of about 1 micron therebetween. The monofilament yarns generally have a denier of greater than about 14, and less than about 400, including all increments of about 1 denier therebetween.

In an alternate embodiment, the yarns used to construct the light transmitting material can be multifilament yarns. Some multifilament yarns may be selected for a light diffusing material with increased flexibility in one or more directions. The number of filaments in each yarn may be selected to achieve the desired strength or tactile properties (e.g., softness, texture). For instance, filaments having a diameter of about 1 micron or greater, and 1000 microns or less, including all increments of about 1 micron therebetween, may be combined in any suitable number, such as 2 filaments or greater, and 36 filaments or less, including all increments of 1 filament therebetween, to form a single multifilament yarn. The multifilament yarns, for instance, can have a denier of greater than about 10, and less than about 400, including all increments of about 1 denier therebetween.

The yarns used to form the light transmitting material 10 can have any suitable color. In one embodiment, the yarns can be made with a dark color such as a black color or a grey color. Using darker colored yarns, for instance, may provide various advantages in some embodiments. For instance, dark colored yarns may increase visibility through the light transmitting material 10. Darker colors can also reduce glitter or glisten that may occur when bright light, such as sunshine, is transmitted through the material. Use of dark yarns may be advantageous for the additional reason that sunlight (i.e., UV rays) may not degrade the materials in the covering, and the materials may better retain their strength. In other embodiments, however, a lighter color may be desired. For instance, a lighter color may make the material less noticeable when hanging within a room.

The yarns used to form the light transmitting material 10 can be provided with any desirable color using coloring agents, such as pigments, dyes and the like. For instance, in one embodiment, the yarns can be solution dyed. For example, one or more coloring agents can be added to a molten polymer when making the fibers that are used to construct the yarns. In this manner, the coloring agent becomes dispersed and saturated throughout the yarn. The solution dying process generally works well for preparing single color yarn, which can be used to make long lasting exterior fabrics which are more resistant to ultraviolet light degradation. The embedded coloring agent or pigment may act to block UV rays and consequent UV degradation. When producing darker yarns, the coloring agent may be carbon black or other pigment.

In addition to solution dyed yarns, the yarns can also be dyed using, for example, dispersion dyes after manufacturing the yarn. For example, the yarns can be dyed by printing with a dye using, for example, a roller prior to or after constructing the fabric. One or more sides of the fabric, for instance, can be printed.

The basis weight of the light transmitting material 10 varies depending upon the type of yarns, the size of yarns used to make the material and the amount of openness in the material. In general, the basis weight of the material may be selected so that the material has sufficient strength and excellent dimensional stability characteristics while also not adding an undesirable amount of weight to the covering for the architectural feature. In general, the basis weight of the light transmitting material is greater than about 20 gsm, and less than about 100 gsm, including all increments of about 1 gsm therebetween.

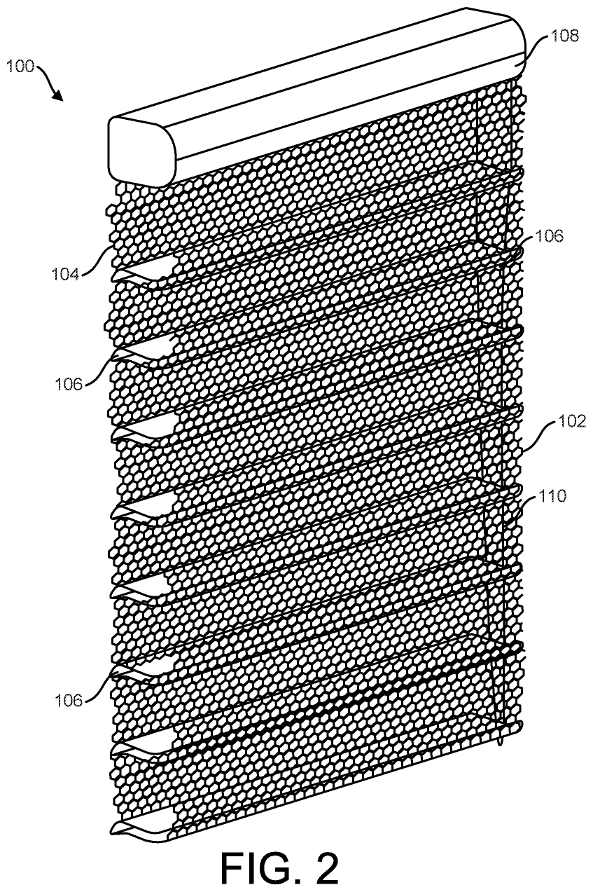

The light transmitting material 10 as shown in FIG. 1 can be incorporated into all different types of coverings for architectural features without limitation. For example, referring to FIG. 2, one example of a covering 100 made in accordance with the present disclosure is shown. The covering 100 includes a front vertical support member 102 that is positioned parallel with a back or rear vertical support member 104. In between the front vertical support member 102 and the back vertical support member 104 are a plurality of movable generally horizontal vane elements 106. The horizontal vane elements 106 can have a different light transmissivity or translucence than the vertical support members 102 and 104. In this manner, the vertical support members 102 and 104 in combination with the vane elements 106 can control the amount of light that is transmitted through the covering. The shape and angular orientation of the vane elements 106 can be controlled by moving the vertical support members 102 and 104 laterally and vertically with respect to each other to further adjust the amount of light transmitted through the covering 100. For instance, the vane elements 106 can be rotated or pivoted between different angular orientations from generally horizontal to vertical with respect to the vertical support members 102 and 104 in order to control light, view-through, shading effect and/or privacy within a room. The entire assembly that makes up the covering 100 can be substantially flexible so that the front and back vertical support members 102 and 104 and the vane elements 106 can be raised and lowered. By selecting suitable materials for the support members 102 and 104, including the appropriate openness factor, in combination with suitable material(s) and volumetric look of the vane elements 106, the function and aesthetic appeal of the covering 100 may be varied.

The covering 100, in one embodiment, includes a head rail 108. Additionally, an operating mechanism may be provided for facilitating raising and lowering of the covering. For example, in one embodiment, the head rail 108 can include a roller (not shown) that is connected or associated with the front vertical support member 102 and the back vertical support member 104. The covering 100 can include a mechanism that rotates the roller for raising and lowering the front and back vertical support members 102 and 104 in conjunction with the vane elements 106. Not shown, the covering 100 can also include a bottom rail or weight for providing further stability to the covering 100.

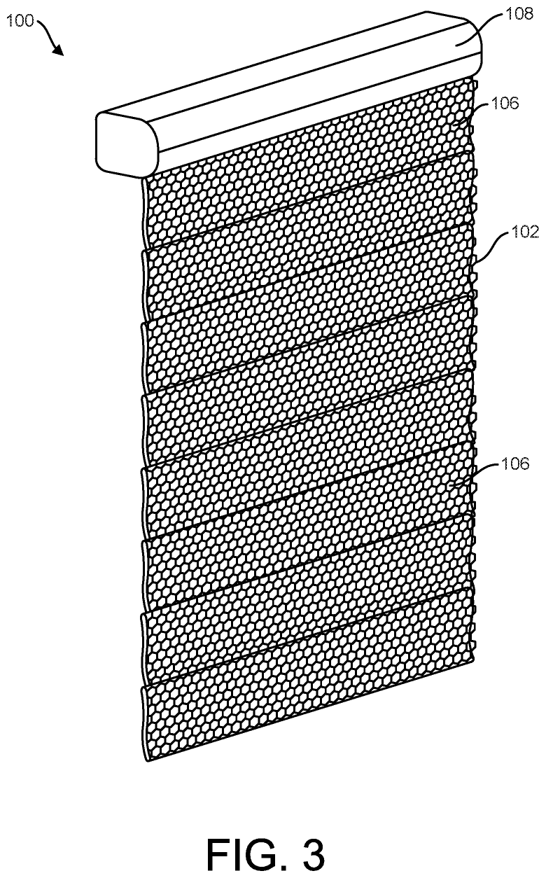

The operating mechanism for raising and lowering the front and back vertical support members 102 and 104 can vary. In one embodiment, the mechanism can be connected to one or more operating cords or drawstrings 110. The one or more drawstrings 110 can be used to rotate the vane elements 106 and/or to raise or lower the front and back vertical support members 102 and 104. In one embodiment, for instance, the cord 110 can be used to rotate the vane elements 106 and then raise the entire structure including the front and back vertical support members 102 and 104 and the vane elements 106 onto a roller. In one embodiment, the front and back vertical support members 102 and 104 can be coupled directly or indirectly to the roller at different horizontally extending locations along the circumference of the roller to provide lateral movement of the front and rear vertical support members relative to each other. The horizontal extending vane elements 106 may be coupled to the front vertical support member 102 along one edge and coupled to the back vertical support member 104 along an opposite edge. In this manner, moving or shifting the front vertical support member 102 in relation to the back vertical support member 104 may cause an angular rotation of the vane elements 106. The vane elements 106 can rotate from a horizontal position as shown in FIG. 2 to a vertical position as shown in FIG. 3. In the horizontal or open position of the vane elements 106 as shown in FIG. 2, the maximum transmission of light through the covering 100 may occur. When the vane elements 106 are rotated to the vertical or closed position as shown is FIG. 3, however, the minimum amount of light may be transmitted through the covering 100. The vane elements 106 can be rotated at any angular position between the horizontal position as shown in FIG. 2 and the vertical position as shown in FIG. 3.

The vane elements 106 can be formed from various materials including fabrics, strips, tapes, panels, and the like. Each vane element may be formed from a single piece of material or multiple pieces of material. The vane elements may be single layered or multilayered. In general, the vane elements 106 may extend in a horizontal direction and each vane element 106 may have a length that is greater than its width. The length of the vane elements 106 generally corresponds with the width of the covering 100. In one embodiment, the vane elements 106 are made from flexible, soft materials to form a generally flexible subassembly or panel for the covering 100. The horizontal vane elements 106 may also have varying light transmissivity properties, varying from blackout, opaque, partially opaque, translucent, transparent, or clear. In one embodiment as shown in FIG. 2, the vane elements 106 can include a hollow interior and form horizontal cells.

When constructing a covering 100 having two support members 102 and 104 formed as sheers, factors such as strength, durability, stretch, UV degradation, and moiré light interference are all factors in the design of an acceptable covering 100. Moiré may occur as a result of light interference when two sheer materials overlay each other, and light is transmitted therethrough. Moiré is preferably avoided or at least minimized and reduced when producing a covering, particularly coverings for windows and the like where light passes therethrough.

One manner of reducing moiré is to use different sheer fabrics for the front and rear sheets and/or selecting, processing and/or configuring sheer fabrics so that the yarns, and interstitial spacing and connection points do not align or nearly align. For example, one way to reduce moiré is to provide a front sheet (e.g. sheer) and a back sheet (e.g. sheer) that have different shaped openings and/or different orientations of openings. Moiré may further be reduced where the front and rear sheets (e.g. sheers) have different sized openings between the yarns, and further where the sized openings are not low multiples of each other. For example, using different fabrics having different shaped openings, (for example, hexagon versus diamond or rectangular) and different sized openings is useful to reduce moiré. In addition, avoiding or reducing the multiples (number of times) that the yarns align or nearly align may reduce moiré. Using a width and/or length dimension for the openings in the first sheet that are not a low multiple of (e.g., not less than 1.2 times larger than) the width and/or length dimension for the openings in the second sheet is believed to assist with reducing moiré. For example, it is preferable to use an opening in the second sheer whose width is about 1.3 or more times larger or smaller than the width of the opening in the first sheer. Similarly, the opening in the first sheer in the length direction is preferably about 1.3 or more times larger or smaller than the opening in the second sheer in the length direction. In one example, a first sheer can be used in combination with a second sheer where the opening of the second sheer is about 1.5 times larger or smaller in the width direction and about 3.4 times larger or smaller in the length direction.

As shown in FIGS. 2 and 3, the front vertical support member 102 and the back vertical support member 104 can be formed from sheer materials that have a desired amount of openness in conjunction with sufficient dimensional stability and strength. In accordance with the present disclosure, the light transmitting material 10 can be used to form the front vertical support member 102 and/or the back vertical support member 104. In one embodiment, both the front vertical support member 102 and the back vertical support member 104 are formed from light transmitting materials in accordance with the present disclosure. The light transmitting materials of the front vertical support member 102 and the back vertical support member 104, however, can be the same or can have different characteristics. For instance, the light transmitting materials can have a different openness factor and/or can be made from different colors. For example, in one embodiment, the back vertical support member 104 can be formed from yarns having a dark color while the front vertical support member 102 can be made from yarns have a lighter color.

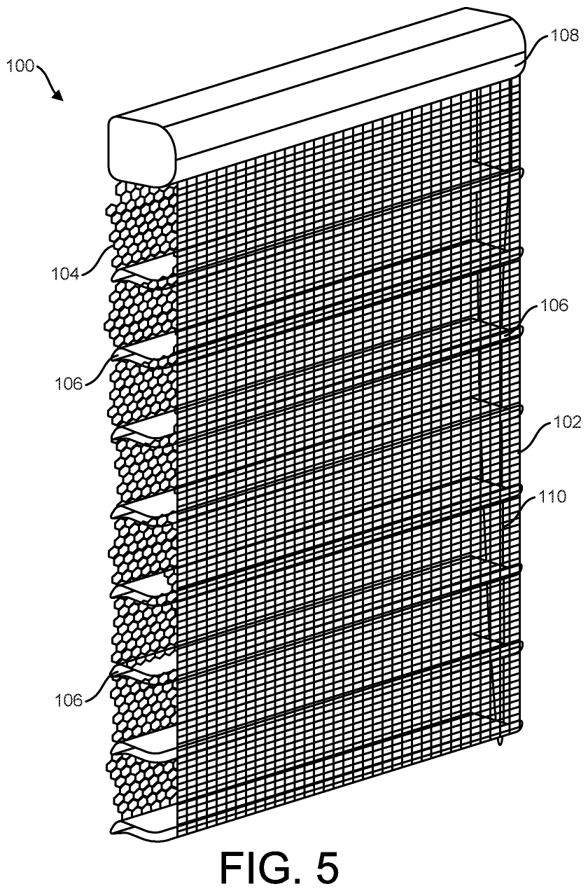

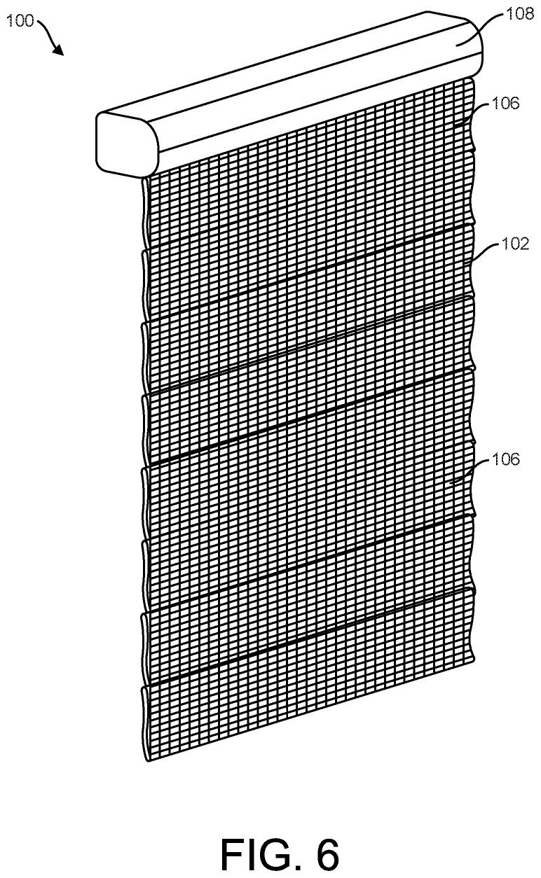

In one embodiment, as shown in FIGS. 5 and 6, the light transmitting material 10 of the present disclosure is combined with a different sheer material in constructing the front vertical support member 102 and the back vertical support member 104. For example, in one embodiment, the light transmitting material 10 of the present disclosure can form either the front vertical support member 102 or the back vertical support member 104 and a different sheer material can be used to construct the other vertical support member. For example, in the embodiment shown in FIGS. 5-6, the light transmitting material 10 of the present disclosure forms the back vertical support member 104 while the front vertical support member 102 can be made from a sheer material having an orthogonal grid pattern, such a grid-like pattern comprised of squares, rectangles or diamonds. The sheer material having an orthogonal grid pattern can be, for example, a tulle knit fabric, or any other suitable knit fabric. Combining the light transmitting material 10 of the present disclosure comprised of polygons having five or more sides, such as hexagons or octagons, with a sheer material having a grid-like pattern may reduce moiré. The openings within the light transmitting material 10 can be larger or smaller than the openings in the sheer fabric having the grid-like pattern as described above. By constructing a covering 100 as shown in FIGS. 5 and 6, in one embodiment, the product can be designed in order to minimize or reduce moiré.

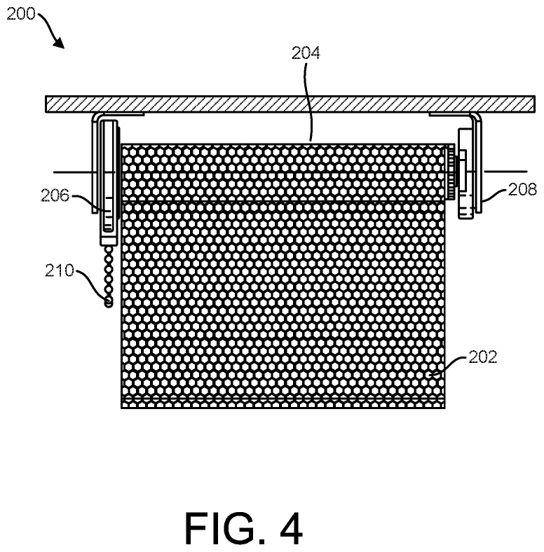

Referring now to FIG. 4, a rear view of another example of an embodiment of a covering 200 for an architectural feature in accordance with the present disclosure is shown. The covering 200 includes a vertical support member 202 made from the light transmitting material 10 of the present disclosure. The light transmitting material 202 is mounted onto a rotatable roller 204. The roller 204 may be contained within a head rail 208 that may include a mechanism 206 that rotates the roller 204 for causing the vertical member 202 to extend and retract. For example, the mechanism 206 can include a cord 210 that allows a user to rotate the roller 204. In the embodiment illustrated in FIG. 4, the covering 200 is mounted within an architectural feature, such as a window.

In one embodiment, the vertical member 202 of the covering 200 can be made only from the light transmitting material 10 of the present disclosure. Alternatively, the light transmitting material 10 of the present disclosure can be combined with other materials to form a laminate. For instance, the light transmitting material 10 can be laminated to a woven fabric, a nonwoven fabric, or a knitted fabric in order to control the amount of light transmission through the vertical member.

While the foregoing Detailed Description and drawings represent various embodiments, it will be understood that various additions, modifications, and substitutions may be made therein without departing from the spirit and scope of the present subject matter. Each example is provided by way of explanation without intent to limit the broad concepts of the present subject matter. In particular, it will be clear to those skilled in the art that principles of the present disclosure may be embodied in other forms, structures, arrangements, proportions, and with other elements, materials, and components, without departing from the spirit or essential characteristics thereof. For instance, features illustrated or described as part of one embodiment can be used with another embodiment to yield a still further embodiment. Thus, it is intended that the present subject matter covers such modifications and variations as come within the scope of the appended claims and their equivalents. One skilled in the art will appreciate that the disclosure may be used with many modifications of structure, arrangement, proportions, materials, and components and otherwise, used in the practice of the disclosure, which are particularly adapted to specific environments and operative requirements without departing from the principles of the present subject matter. For example, elements shown as integrally formed may be constructed of multiple parts or elements shown as multiple parts may be integrally formed, the operation of elements may be reversed or otherwise varied, the size or dimensions of the elements may be varied. The presently disclosed embodiments are therefore to be considered in all respects as illustrative and not restrictive, the scope of the present subject matter being indicated by the appended claims, and not limited to the foregoing description.

In the foregoing Detailed Description, it will be appreciated that the phrases “at least one”, “one or more”, and “and/or”, as used herein, are open-ended expressions that are both conjunctive and disjunctive in operation. The term “a” or “an” element, as used herein, refers to one or more of that element. As such, the terms “a” (or “an”), “one or more” and “at least one” can be used interchangeably herein. All directional references (e.g., proximal, distal, upper, lower, upward, downward, left, right, lateral, longitudinal, front, rear, top, bottom, above, below, vertical, horizontal, cross-wise, radial, axial, clockwise, counterclockwise, and/or the like) are only used for identification purposes to aid the reader's understanding of the present subject matter, and/or serve to distinguish regions of the associated elements from one another, and do not limit the associated element, particularly as to the position, orientation, or use of the present subject matter. Connection references (e.g., attached, coupled, connected, joined, secured, mounted and/or the like) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

All apparatuses and methods disclosed herein are examples of apparatuses and/or methods implemented in accordance with one or more principles of the present subject matter. These examples are not the only way to implement these principles but are merely examples. Thus, references to elements or structures or features in the drawings must be appreciated as references to examples of embodiments of the present subject matter, and should not be understood as limiting the disclosure to the specific elements, structures, or features illustrated. Other examples of manners of implementing the disclosed principles will occur to a person of ordinary skill in the art upon reading this disclosure.

This written description uses examples to disclose the present subject matter, including the best mode, and also to enable any person skilled in the art to practice the present subject matter, including making and using any devices or systems and performing any incorporated methods. The patentable scope of the present subject matter is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The following claims are hereby incorporated into this Detailed Description by this reference, with each claim standing on its own as a separate embodiment of the present disclosure. In the claims, the term “comprises/comprising” does not exclude the presence of other elements or steps. Furthermore, although individually listed, a plurality of means, elements or method steps may be implemented by, e.g., a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second”, etc., do not preclude a plurality. Reference signs in the claims are provided merely as a clarifying example and shall not be construed as limiting the scope of the claims in any way.

What is claimed:

1. A covering for an architectural feature, said covering comprising:
a light transmitting material that extends vertically, said light transmitting material having an openness factor of about 60% or greater, said light transmitting material comprising a pattern of geometric shapes, said geometric shapes having six sides or greater.

2. A covering as defined in claim 1, wherein said geometric shapes comprise regular polygons.

3. A covering as defined in claim 1, wherein said geometric shapes comprise hexagons.

4. A covering as defined in claim 3, wherein said light transmitting material comprises a knitted fabric.

5. A covering as defined in claim 3, wherein said knitted fabric is formed from monofilament yarns.

6. A covering as defined in claim 5, wherein said monofilament yarns have a diameter of from about 25 microns to about 1000 microns.

7. A covering as defined in claim 5, wherein said monofilament yarns are solution dyed.

8. A covering as defined in claim 7, wherein said monofilament yarns have a black or grey color.

9. A covering as defined in claim 5, wherein each side of each hexagon is formed by at least two monofilament yarns.

10. A covering as defined in claim 3, wherein said geometric shapes are in a pattern of alternating columns, said columns extending in a length direction of said light transmitting material.

11. A covering as defined in claim 3, wherein said light transmitting material has a basis weight of from about 30 gsm to about 800 gsm.

12. A covering as defined in claim 3, wherein said light transmitting material has a first direction and wherein said hexagons each include two sides parallel to said first direction and wherein said two sides each include at least one stitch.

13. A covering as defined in claim 12, wherein said sides adjacent to said parallel sides of each hexagon are slanted with respect to said first direction.

14. A covering as defined in claim 13, wherein said two sides parallel to said first direction each include at least two stitches to at most five stitches.

15. A covering as defined in claim 14, wherein said stitches are formed by intersecting knitted loops.

16. A covering as defined in claim 3, wherein said light transmitting material has a first direction, further wherein said material is formed from knitted yarns, wherein each knitted yarn includes a series of loops extending in said first direction, each series of knitted loops being periodically interlocked with adjacent series of knitted loops on opposite sides thereof.

17. A covering as defined in claim 3, wherein said light transmitting material has an openness factor of about 70% or greater.

18. A covering as defined in claim 3, wherein said light transmitting material has an openness factor of about 75% or greater.

19. A covering as defined in claim 3, wherein said covering includes a roller and wherein said light transmitting material is engaged with said roller and configured to retract and extend by winding and unwinding said roller as a result of winding around and unwinding from said roller.

20. A covering as defined in claim 3, comprising:
a front vertical support member having a height and a width;
a rear vertical support member having a height and a width, said rear vertical support member being parallel to said front vertical support member;
a plurality of generally horizontal vanes extending between said front and rear vertical support members, said horizontal vanes being configured to move at an angular orientation with respect to said front vertical support member and said rear vertical support member;
wherein at least one of said front vertical support member or said rear vertical support member is formed from said light transmitting material.

21. A covering as defined in claim 20, wherein said front vertical support member is formed from said light transmitting material and wherein said rear vertical support member is formed from a second light transmitting material, said second light transmitting material having an openness factor of about 60% or greater, said second light transmitting material comprising a pattern of geometric shapes, said geometric shapes comprising hexagons.

22. A covering as defined in claim 20, wherein the front vertical support member is formed from said light transmitting material and said rear vertical support member is formed from a sheer fabric having a grid-like pattern.

23. A covering as defined in claim 22, wherein said sheer fabric comprises a pattern of squares, rectangles, or diamonds.
